(19) United States
(12) Patent Application Publication
(10) Pub. No.: US 2009/0158789 A1
(43) Pub. Date: Jun. 25, 2009

(54) LOCKABLE SHUTTER ASSEMBLY

(76) Inventors: Nathan D. Greenway, Attica, MI (US); Brad A. Kutler, Oxford, MI (US); Clyde G. Allen, Columbiaville, MI (US)

Correspondence Address: HOWARD & HOWARD ATTORNEYS PLLC, 450 West Fourth Street, Royal Oak, MI, 48067, US

(21) Appl. No.: 12/338,730

(22) Filed: Dec. 18, 2008

Related U.S. Application Data
(60) Provisional application No. 61/015,030, filed on Dec. 19, 2007.

(51) Int. Cl. E05B 65/00; A47B 96/06

(52) U.S. Cl. 70/77; 248/205.1

(57) ABSTRACT

A lockable shutter assembly has first and second shutters mounted operatively to a building and movable between open and closed positions. The locking assembly includes a bracket member that extends longitudinally along a gap formed between the shutters when in the closed position. The bracket member is mounted at its respective ends to top and bottom portions of a shutter opening via mounting plates. The bracket member includes at least one through bore formed along the length of the bracket member. A selectively releasable interlock member is slidably received in the through bore. The locking device can releasably engage the bracket member and/or the interlock member. Another interlock member can be used to secure the locking device to the bracket member.

### CROSS-REFERENCE TO RELATED APPLICATION

The instant application claims priority to U.S. Provisional Patent Application Ser. No. 61/015,030, filed Dec. 19, 2007, the entire specification of which is expressly incorporated herein by reference.

### FIELD OF THE INVENTION

The subject invention generally relates to a shutter assembly, and more particularly, to a reinforced, locking, shutter assembly that is operable to withstand inclement weather conditions.

### BACKGROUND OF THE INVENTION

Various locking assemblies for shutters are known in the art. It is generally known that locking assemblies are utilized, when necessary, to lock pairs of shutters in a closed position on a dwelling. Shutters are used for both aesthetic and functional purposes on the dwelling. In the closed position, the shutters function to protect windows, doors, and other openings of the dwelling during inclement weather, such as precipitation storms, wind storms, and hurricanes, as well as the ingress of windblown or airborne debris into the dwelling, e.g., during severe storm conditions.

During such inclement weather, it is desirable to lock, or retain, the shutters in the closed position such that the shutters can continue to provide adequate protection to the windows, doors, and other openings during and throughout the inclement weather conditions. If the weather causes the shutters to open, then the functional purpose of the shutters is lessened or defeated.

Conventional assemblies for locking pairs of shutters in the closed position are deficient for many reasons. For instance, the locking assemblies of the prior art do not adequately retain the shutters in the closed position throughout the inclement weather conditions. In these assemblies, wind either bends or breaks the assembly causing the shutters to open. Also, many conventional locking assemblies require excessive modification and direct drilling into and through the shutters to adequately retain the shutters in the closed position. In these assemblies, the fastener extends through at least a portion of the shutters. As a result and to a varying degree, these conventional locking assemblies damage the shutters such that, after the inclement weather conditions have subsided, the aesthetic purpose of the shutters is negatively impacted.

Furthermore, some conventional locking assemblies, also referred to in the art as storm or locking bars, create an emergency egress issue that prevents occupants of the dwelling from escaping during an emergency situation, such as a fire. More specifically, a conventional storm bar is mounted across the shutters once the shutters have been closed. The storm bar is secured, e.g., typically screwed, into the dwelling on each side of the closed shutters to prevent the shutters from opening during the inclement weather. Screws are also used to connect the shutters to the storm bar such that the shutters can not be blown, or otherwise deflected, inward, i.e., toward the dwelling, during the inclement weather conditions. With the storm bar screwed to the dwelling and the shutter screwed to the storm bar, the occupants of the dwelling cannot open a window or door from within the dwelling to release the storm bar and thus effectuate an escape.

Due to the deficiencies in the locking assemblies of the prior art, including those described above, it is desirable to provide a new and improved locking assembly for shutters that adequately retains the shutters in a closed position on a dwelling such that protection to a window, door, or other opening is maximized throughout any inclement weather conditions. It is also desirable to provide a locking assembly for shutters that can be easily unlocked and opened from either side, and when unlocked, is clear of the opening.

### SUMMARY OF THE INVENTION

A lockable shutter assembly has first and second shutters mounted operatively to a building and movable between open and closed positions. The locking assembly includes a bracket member that extends longitudinally along a gap formed between the shutters when in the closed position. The bracket member is substantially T-shaped with a longitudinally extending planar flange member having a gap formed along a central longitudinal portion thereof. The bracket member is mounted at its respective ends to top and bottom portions of a shutter opening via mounting plates. The bracket member includes at least one, preferably at least two, and more preferably, a plurality of through bores formed along the length of the bracket member.

A selectively releasable interlock member is slidably received in each of the through bores. The interlock members can be formed to be fully disposed through both ends of the through bores. The shutters can be positioned in their closed position either before or after the insertion of the interlock members in the through bores.

Once the shutters are positioned in their closed position, the locking device can be deployed. The locking device includes a generally T-shaped member having a web portion disposed laterally between and perpendicular to a longitudinally extending planar flange portion. The flange portion can be provided with one or more handle members to aid in carrying and placement of the locking device. The web portion includes at least one, preferably at least two, and more preferably, a plurality of substantially L-shaped cutout portions formed therein. The web portion is preferably disposed within the gap of the flange member of the bracket member such that a first portion (e.g., a horizontally oriented slot) of the cutout portions is able to engage a first surface the interlock members slidably received in each of the through bores. The locking device can then by positioned downwardly such that a second portion (e.g., a vertically oriented slot) of the cutout portions is able to engage a second surface of the interlock members slidably received in each of the through bores so as to ensure that the locking device can not be easily dislodged from the bracket member. In this manner, the shutters can be held securely in place in the closed position during any type of inclement weather conditions.

In accordance with an alternative embodiment of the present invention, an alternative locking assembly includes a bracket member that, when deployed, extends longitudinally along a gap formed between the shutters, when in the closed position. The bracket member is substantially t-shaped or cross-shaped with a first portion bisecting a second portion, wherein the first portion is transverse and/or perpendicular to the second portion. The respective sectional lengths and/or widths of the first and second portions can vary with respect to one another. At least one of the first and second portions is provided with at least one area defining an aperture formed therein. In accordance with one aspect of the present invention, the apertures are provided on both the inboard and outboard surfaces of the first portion. The respective sectional lengths and/or widths of the inboard and outboard surfaces can vary with respect to one another.

The bracket member is mounted at its respective ends to the top and bottom frames of the opening via mounting plates. The mounting plates can be mounted using various fasteners, including but not limited to anchors and screws. The mounting plates preferably include at least one, preferably at least two, and more preferably, a plurality of through bores formed therein. By way of a non-limiting example, the through bores preferably align with one of the apertures formed in the bracket member when the bracket member is disposed in or engaged to either of the mounting plates.

A selectively releasable interlock member is slidably received in each of the aligned apertures and through bores. By way of a non-limiting example, the interlock member is preferably disposed between the aligned apertures on the inboard portion and through bores. The interlock members can be formed to be fully disposed through both ends of the through bores. In this manner, the bracket member is securely held in place, especially from the interior of the building or dwelling. The shutters can be positioned in their closed position either before or after the insertion of the interlock members in the aligned apertures and through bores, subject to clearance concerns. However, provided that the interlock members do not interfere with the free movement of the shutters, this should not be a great concern.

Once the shutters are positioned in their closed position, a locking device may be deployed. The locking device includes a generally cross-, x-, or t-shaped member having a longitudinal central groove formed therein to form two flange portions. A web portion extends from the flange portions and envelopes the groove. The flange portions can be provided with protective surfaces (e.g., formed of polycarbonate) to prevent damage to the shutters or augment the width and size of the flange portions. The protective surfaces can be secured to the flange portions with fasteners, such as but not limited to screws. The web portion is provided with at least one area defining through bores (essentially aligned bores on either side of the web portion) formed along the length thereof, the purpose of which will be explained herein. Preferably, the through bores are able to substantially align with at least one of the apertures formed on the outboard surface of the first portion.

During deployment, the groove of the web portion is preferably disposed over the outboard surface of the first portion such that the through bores align with at least one of the apertures of the outboard surface of the first portion. Preferably, several of the respective through bores and apertures align. Once this occurs, a second releasable interlock member is slidably received in each of the aligned apertures and through bores. By way of a non-limiting example, the interlock member is preferably disposed between the aligned apertures on the outboard portion and through bores. The interlock members can be formed to be fully disposed through both ends of the through bores. In this manner, the locking device is securely releasably joined to the bracket member, especially from the exterior of the building or dwelling, thus ensuring that the shutters can be held in their closed position during any type of weather conditions. Movement or dislodgement of the locking device in this orientation would take a tremendous amount of force. Essentially, the interlock members would have to be blown or knocked out of position to permit the locking device to be removed from the bracket member. In an emergency situation wherein the occupants had to exit the structure exclusively through the window, the window (e.g., a slider, double hung, or inwardly opening casement window design) could be opened and the locking device could be manually lifted out of its resting position and removed by the occupants wherein the shutters could be easily pushed open.

Objects, features and advantages of the present invention include a shutter assembly that can be unlocked and opened, and closed and locked from the interior of a building. Other advantages include a locking device that adds strength and rigidity to the shutters when in the closed position to resist inclement weather. Yet further, the assembly is relatively attractive when in the open position, relatively simple and robust in design, inexpensive to manufacture and in service has a long and useful life.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a shutter assembly having a pair of shutters illustrated in an open position, with a bracket member of the locking assembly of the present invention disposed therebetween;

FIG. 2 is a partial perspective view of the bracket member including an interlock member slidably disposed in a through bore of the bracket member with a locking device of the locking assembly of the present invention shown in an non-deployed position;

FIG. 3 is a perspective view of the locking device of the locking assembly of the present invention;

FIG. 4 is a side view of the locking device of the locking assembly of the present invention;

FIG. 5 is a perspective view of a shutter assembly having a pair of shutters illustrated in a closed position, with the locking device of the locking assembly of the present invention in an non-deployed position;

FIG. 6 is a perspective view of a shutter assembly having a pair of shutters illustrated in a closed position, with the locking device of the locking assembly of the present invention in a deployed position;

FIG. 7 is a sectional view taken along line 7-7 of FIG. 6;

FIG. 8 is a perspective view of a shutter assembly having a pair of shutters illustrated in the closed position, with an alternative bracket member of an alternative locking assembly of the present invention disposed therebetween;

FIG. 9 is an exploded view of the alternative locking assembly of the present invention;

FIG. 10 is a partial exploded view of the alternative locking assembly of the present invention;

FIG. 11 is an elevational view of a shutter assembly having a pair of shutters illustrated in the closed position, with an alternative bracket member of an alternative locking assembly of the present invention disposed therebetween;

FIG. 12 is a sectional view taken along line 12-12 of FIG. 11;

FIG. 13 is a detail of the sectional view taken along line 12-12 of FIG. 11;

FIG. 14 is a sectional view taken along line 14-14 of FIG. 11;

FIG. 15 is a cross-sectional of an alternative bracket member of an alternative locking assembly of the present invention; and

FIG. 16 is a fragmentary perspective view of an alternative bracket member of an alternative locking assembly of the present invention.

### DETAILED DESCRIPTION OF THE PREFERRED EMBODIMENT

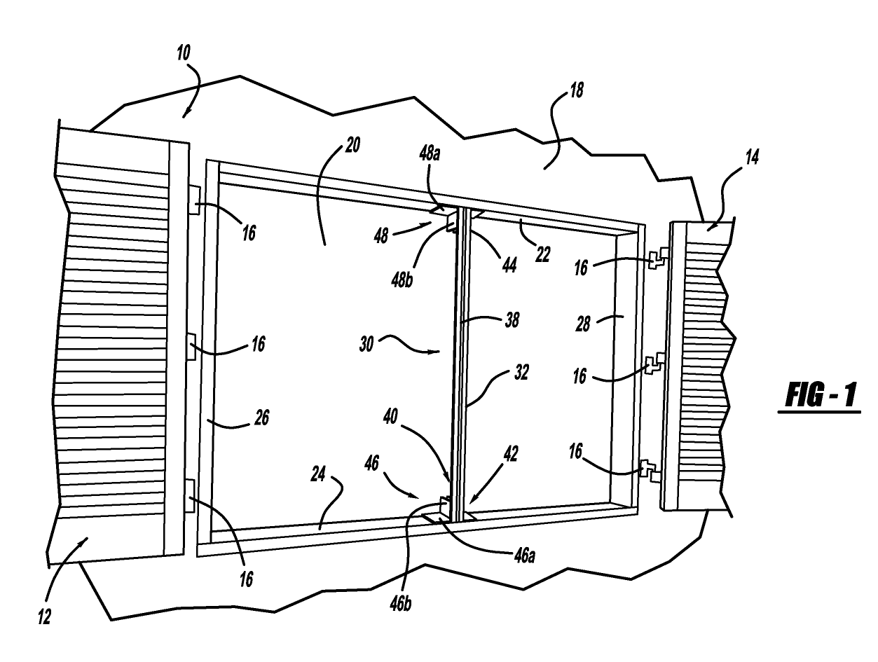

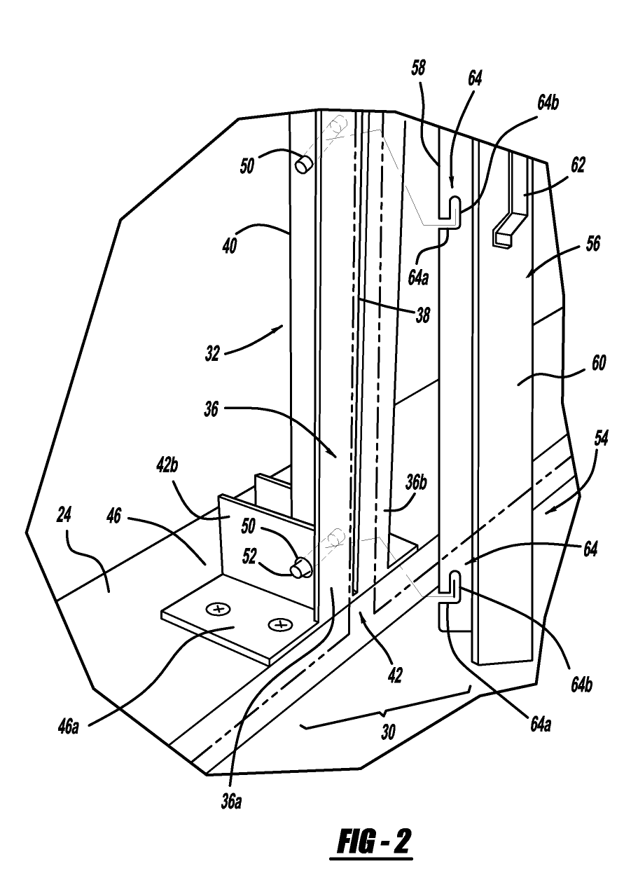

Referring to FIGS. 1-7 generally, and specifically to FIG. 1, wherein like numerals indicate like or corresponding parts throughout the several views, a shutter assembly 10 of the present invention includes a pair of shutters 12, 14 that mount rotatably (e.g., via one or more hinges 16) to the exterior of a structure such as a building or dwelling 18. Preferably, the first or left shutter 12 has a substantially horizontal “swinging” direction of movement and the second or right shutter 14 also has a substantially horizontal “swinging” direction of movement complementary to the first or left shutter 12 so as to be able to substantially cover up an opening 20 (e.g., for a window) formed in the building or dwelling 18. The opening 20 can be provided with top framing 22, bottom framing 24, left side framing 26, and right side framing 28, to enhance the appearance of the opening 20. By way of a non-limiting example, the opening 20 could be provided with a window (not shown for purposes of clarity of illustration) located at the rear portion of the opening 20, with the shutter assembly 10 being located at the front portion of the opening 20, i.e., in front of the window.

Alternatively, the pair of shutters 12, 14 could be configured in an “accordion” style and mounted so as to unfold, extend and slide along the top framing 22 and bottom framing 24 so as to substantially cover up the opening 20.

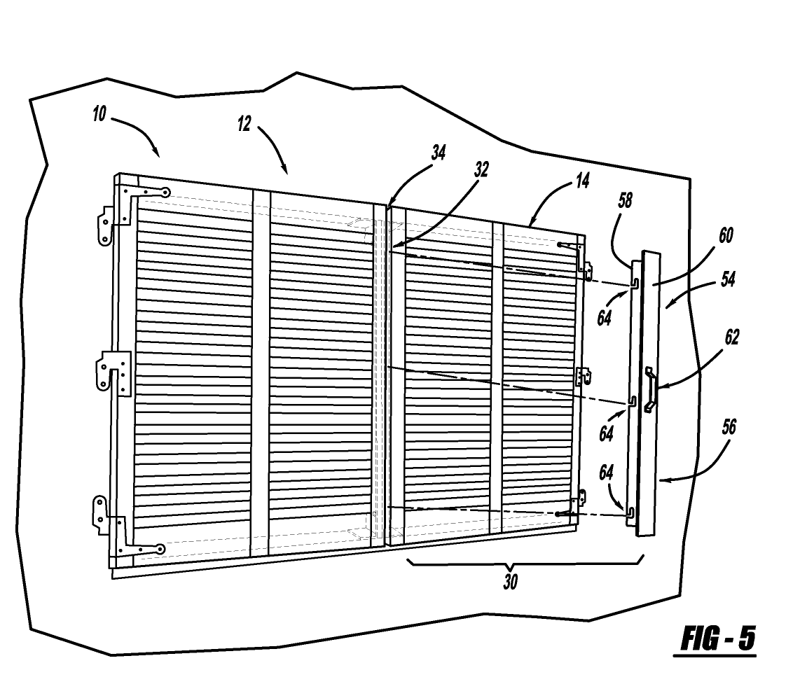

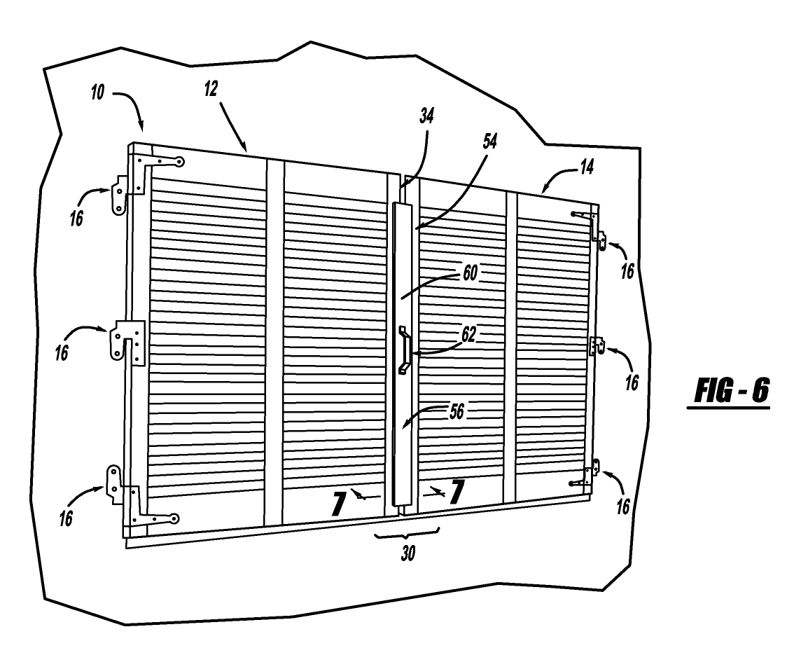

When the shutters 12, 14 are in an open position during mild weather conditions, they preferably lay flat to the structure so as not to obstruct the opening 20. When in a closed position (see FIGS. 5 and 6), the shutter assembly 10 protects the windows and/or doors from inclement weather, such as precipitation, storms, wind storms, hurricanes, and/or the like. To accomplish this protection, the shutter assembly 10 has an associated locking assembly device 30 that reinforces and locks closed the shutters 12, 14 of the shutter assembly 10.

The locking assembly 30 includes a bracket member 32 that extends longitudinally along a gap 34 formed between the shutters 12, 14, when in the closed position. The bracket member 32 is substantially T-shaped with a longitudinally extending planar flange member 36 (e.g., consisting of two flange faces 36a, 36b) having a gap 38 formed along a central longitudinal portion thereof (e.g., the space between the two flange faces). At least one web portion 40 (e.g., consisting of two web faces 40a, 40b) extends transverse and perpendicular to the flange member 36. The web portion 40 can be integral to, or alternatively joined to, the flange member 36. The bracket member 32 is mounted at its respective ends 42, 44, respectively, to the top and bottom frames 22, 24, respectively, of the opening 20 via mounting plates 46, 48, respectively. The mounting plates 46, 48 can be integral to, or alternatively joined to, the web portion 40 and/or the flange member 36. By way of a non-limiting example, the mounting plates 46, 48, respectively, can be provided with base portions 46a, 48a, respectively, and upstanding wall portions 46b, 48b, respectively.

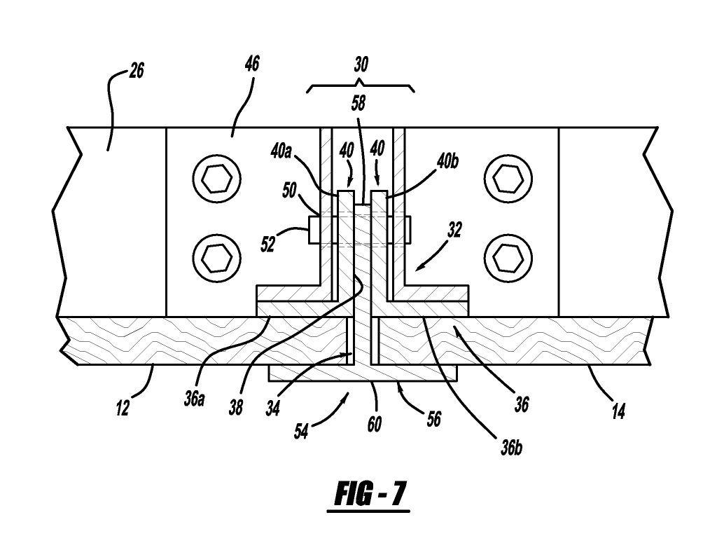

The bracket member 32 includes at least one, preferably at least two, and more preferably, a plurality of through bores 50 formed along the length of the bracket member 32. By way of a non-limiting example, the through bores 50 can be formed by forming aligned bores through the various surfaces of the web portion 40 and the upstanding wall portions 46b, 48b, respectively, of the mounting plates 46, 48 (e.g., see FIG. 7). A selectively releasable interlock member 52 is slidably received in each of the through bores 50. The interlock members 52 can be formed to be fully disposed through both ends of the through bores 50. The shutters 12, 14 can be positioned in their closed position either before or after the insertion of the interlock members 52 in the through bores 50, subject to clearance concerns. However, provided that the interlock members 52 do not interfere with the free movement of the shutters 12, 14, this should not be a great concern.

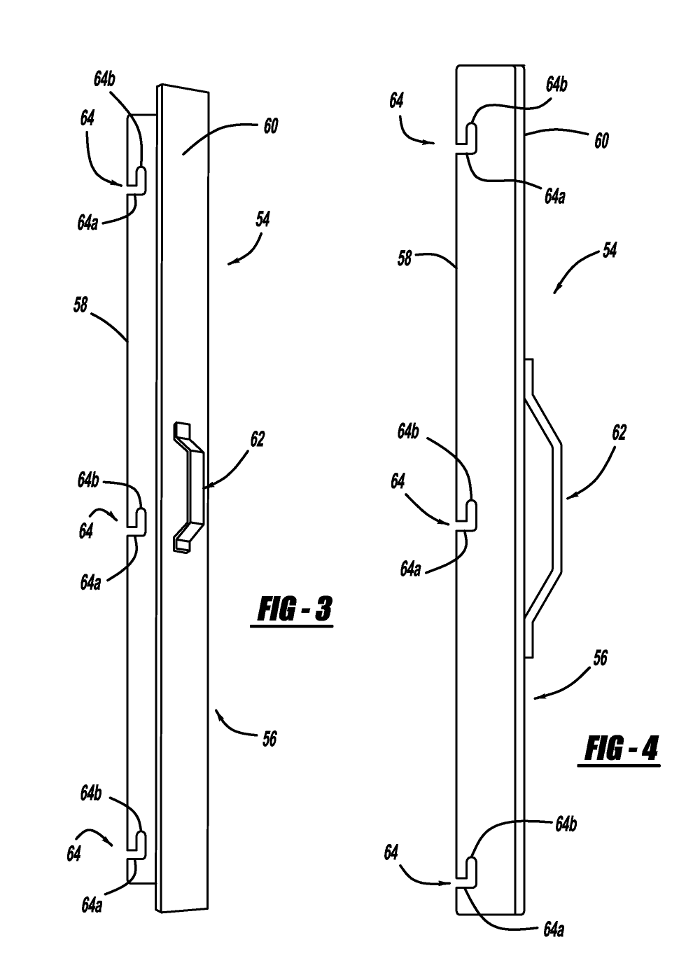

Once the shutters 12, 14 are positioned in their closed position (e.g., see FIGS. 5 and 6), the locking device 54 may be deployed. Referring specifically to FIGS. 3 and 4, the locking device 54 includes a generally T-shaped member 56 having a web portion 58 disposed laterally between and perpendicular to a longitudinally extending planar flange portion 60. The flange portion 60 can be provided with one or more handle members 62 to aid in carrying and placement of the locking device 54. The web portion 58 includes at least one, preferably at least two, and more preferably, a plurality of substantially L-shaped cutout portions 64 formed therein. The cutout portions 64 include a horizontal first portion 64a and a vertical second portion 64b.

During deployment, the web portion 58 is preferably disposed within the gap 38 of the flange member 34 of the bracket member 32 such that a first portion (e.g., a horizontally oriented slot) 64a of the cutout portions 64 is able to engage a first surface of the interlock member 52 that are slidably received in each of the through bores 50. The locking device 54 can then by positioned downwardly such that a second portion 64b (e.g., a vertically oriented slot) of the cutout portions 64 is able to engage a second surface of the interlock members 50 that are slidably received in each of the through bores 50 so as to ensure that the locking device 54 can not be easily dislodged from the bracket member 32. That is, the respective top most portions of the second portions 64b are brought into contact with, and rest upon, the respective interlock members 52. Thus, the entire weight of the locking device 54 rests upon the respective interlock members 52. Movement or dislodgement of the locking device 54 in this orientation would take a tremendous amount of force. Essentially, because of the L-shaped configuration of the cutout portions 64, the locking device 54 would have to travel upwardly or vertically along second portion 64b and outwardly or horizontally along first portion 64a in order to become disengaged from the respective interlock members 52. In this manner, the shutters 12, 14 can be held securely in place in the closed position during any type of inclement weather conditions. In an emergency situation wherein the occupants had to exit the structure exclusively through the window, the window (e.g., a slider, double hung, or inwardly opening casement window design) could be opened and the locking device 54 could be manually lifted out of its resting position and removed by the occupants wherein the shutters 12, 14 could be easily pushed open.

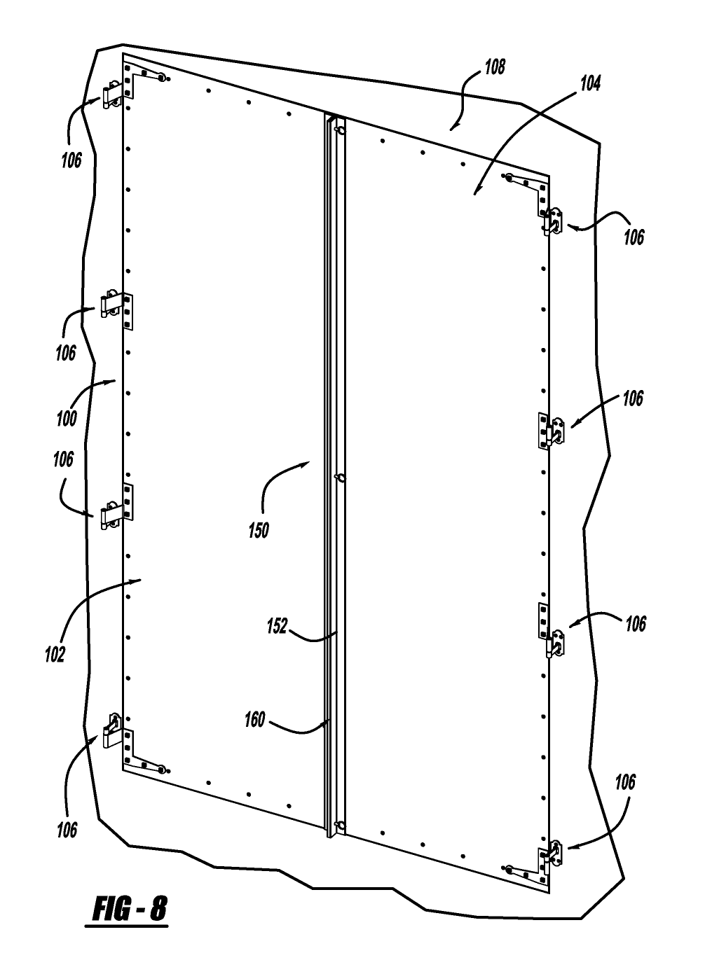

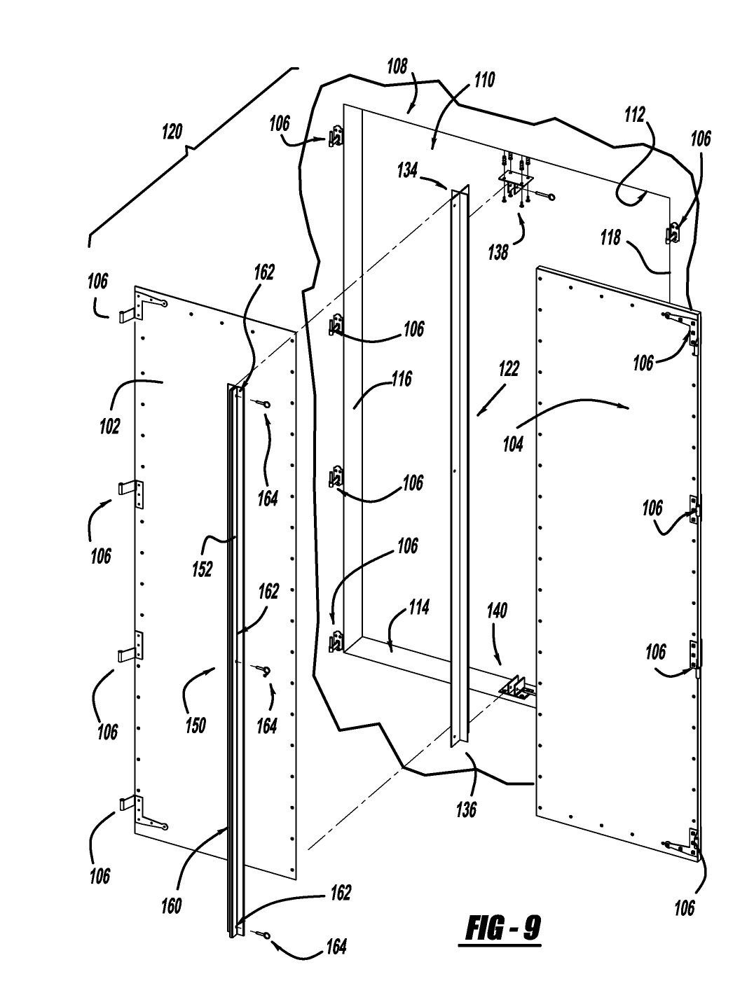

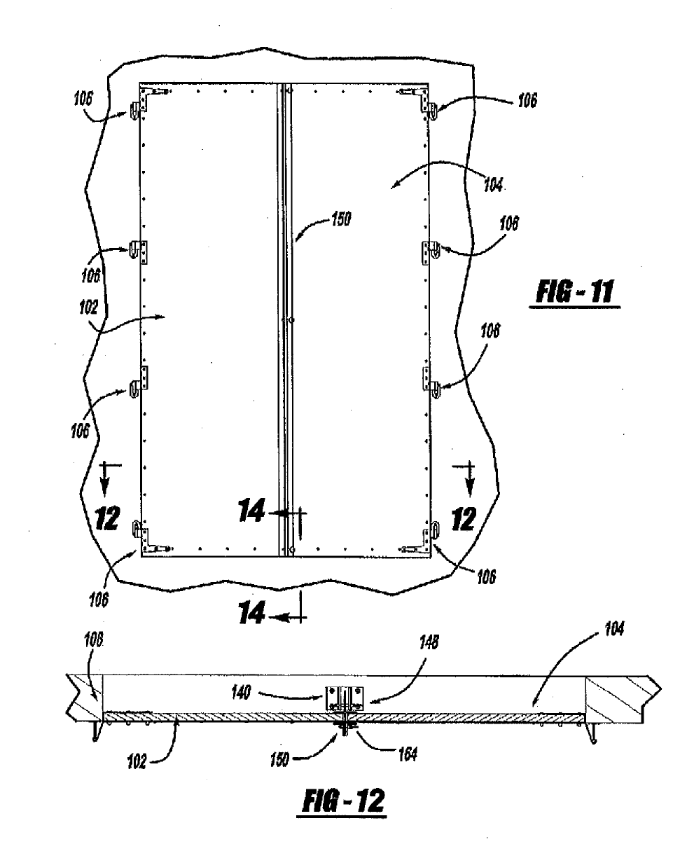

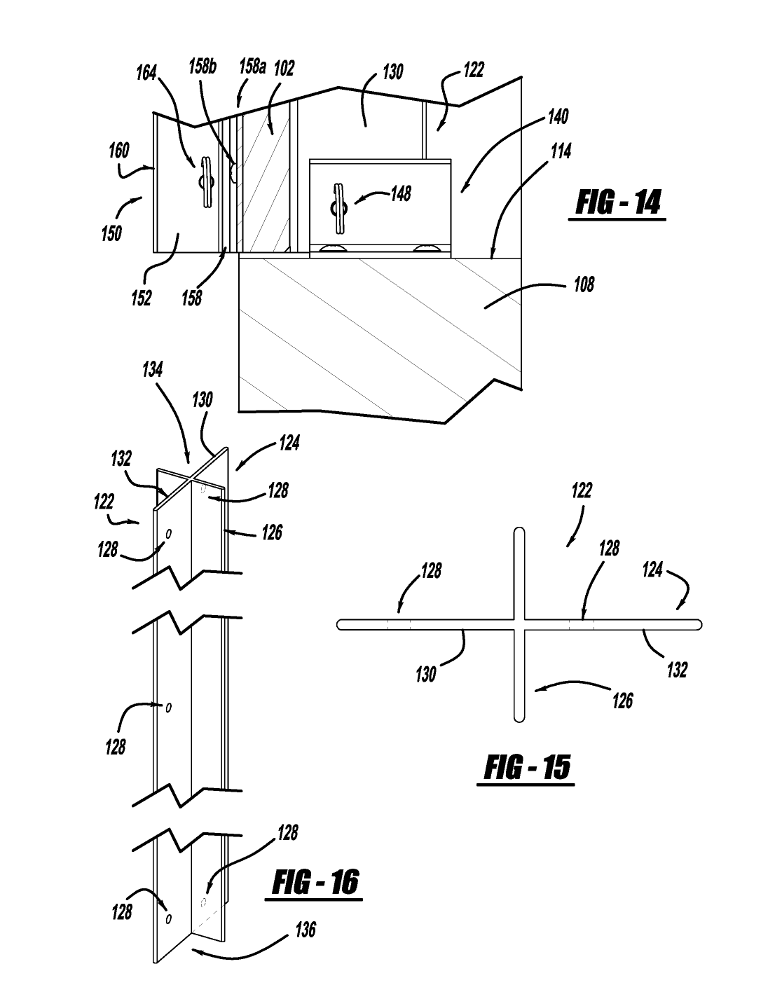

Referring to FIGS. 8-16 generally, and specifically to FIGS. 8 and 9, wherein like numerals indicate like or corresponding parts throughout the several views, a shutter assembly 100 of the present invention includes a pair of shutters 102, 104 that mount rotatably (e.g., via one or more hinges 106) to the exterior of a structure such as a building or dwelling 108. Preferably, the first or left shutter 102 has a substantially horizontal “swinging” direction of movement and the second or right shutter 104 also has a substantially horizontal “swinging” direction of movement complementary to the first or left shutter 102 so as to be able to substantially cover up an opening 110 (e.g., for a window) formed in the building or dwelling 108. The opening 110 can be provided with top framing 112, bottom framing 114, left side framing 116, and right side framing 118, to enhance the appearance of the opening 110. By way of a non-limiting example, the opening 110 could be provided with a window (not shown for purposes of clarity of illustration) located at the rear portion of the opening 110, with the shutter assembly 100 being located at the front portion of the opening 110, i.e., in front of the window.

As with the previously described embodiment, the pair of shutters 102, 104 could be configured in an “accordion” style and mounted so as to unfold, extend and slide along the top framing 112 and bottom framing 114 so as to substantially cover up the opening 110.

As previously noted, when the shutters 102, 104 are in an open position during mild weather conditions, they preferably lay flat to the structure so as not to obstruct the opening 110. When in a closed position (see FIGS. 8 and 11), the shutter assembly 100 protects the windows and/or doors from inclement weather, such as precipitation, storms, wind storms, hurricanes, and/or the like. To accomplish this protection, the shutter assembly 100 has an associated alternative locking assembly device 120 that reinforces and locks closed the shutters 102, 104 of the shutter assembly 100.

The locking assembly 120 includes a bracket member 122 that, when deployed, extends longitudinally along a gap 123 formed between the shutters 102, 104, when in the closed position. The bracket member 122 is substantially cross-shaped, x-shaped, or t-shaped with a first portion 124 bisecting a second portion 126, wherein the first portion 122 is transverse and/or perpendicular to the second portion 124 (e.g., see FIGS. 15 and 16). The respective sectional lengths and/or widths of the first and second portions 124, 126, can vary with respect to one another. At least one of the first and second portions 124, 126 is provided with at least one area defining an aperture 128 formed therein, the purpose of which will be explained herein. In accordance with one aspect of the present invention, the apertures 128 are provided on both the inboard and outboard surfaces 130, 132, respectively, of the first portion 124. The respective sectional lengths and/or widths of the inboard and outboard surfaces 130, 132, can vary with respect to one another.

The bracket member 122 is mounted at its respective ends 134, 136, respectively, to the top and bottom frames 112, 114, respectively, of the opening 110 via mounting plates 138, 140, respectively. The mounting plates 138, 140 can be mounted using various fasteners, including but not limited to anchors 142 and screws 144. The mounting plates 138, 140 preferably include at least one, preferably at least two, and more preferably, a plurality of through bores 146 formed therein. By way of a non-limiting example, the through bores 146 preferably align with one of the apertures 128 formed in the bracket member 122 when the bracket member is disposed in or engaged to either of the mounting plates 138, 140.

A selectively releasable interlock member 148 is slidably received in each of the aligned apertures 128 and through bores 146. By way of a non-limiting example, the interlock member 148 is preferably disposed between the aligned apertures 128 on the inboard portion 130 and through bores 146 (e.g., see FIGS. 10 and 12-14). The interlock members 148 can be formed to be fully disposed through both ends of the through bores 146. In this manner, the bracket member 122 is securely held in place, especially from the interior of the building or dwelling 108. The shutters 102, 104 can be positioned in their closed position either before or after the insertion of the interlock members 148 in the aligned apertures 128 and through bores 146, subject to clearance concerns. However, provided that the interlock members 148 do not interfere with the free movement of the shutters 102, 104, this should not be a great concern.

Once the shutters 102, 104 are positioned in their closed position, a locking device 150 may be deployed. Referring specifically to FIGS. 9, 10 and 13, the locking device 150 includes a generally T-shaped member 152 having a longitudinal central groove 154 formed therein to form two flange portions 156, 158. A web portion 160 extends from the flange portions 156, 158, and envelopes the groove 154. The flange portions 156, 158, can be provided with protective surfaces (e.g., formed of polycarbonate) 156a, 158a, respectively, to prevent damage to the shutters 102, 104 or augment the width and size of the flange portions 156, 158. The protective surfaces 156a, 158a can be secured to the flange portions 156, 158, respectively, with fasteners, such as but not limited to screws 156b, 158b, respectively. The web portion 160 is provided with at least one area defining through bores 162 (essentially aligned bores on either side of the web portion 160) formed along the length thereof, the purpose of which will be explained herein. Preferably, the through bores 162 are able to substantially align with at least one of the apertures 128 formed on the outboard surface 132 of the first portion 124.

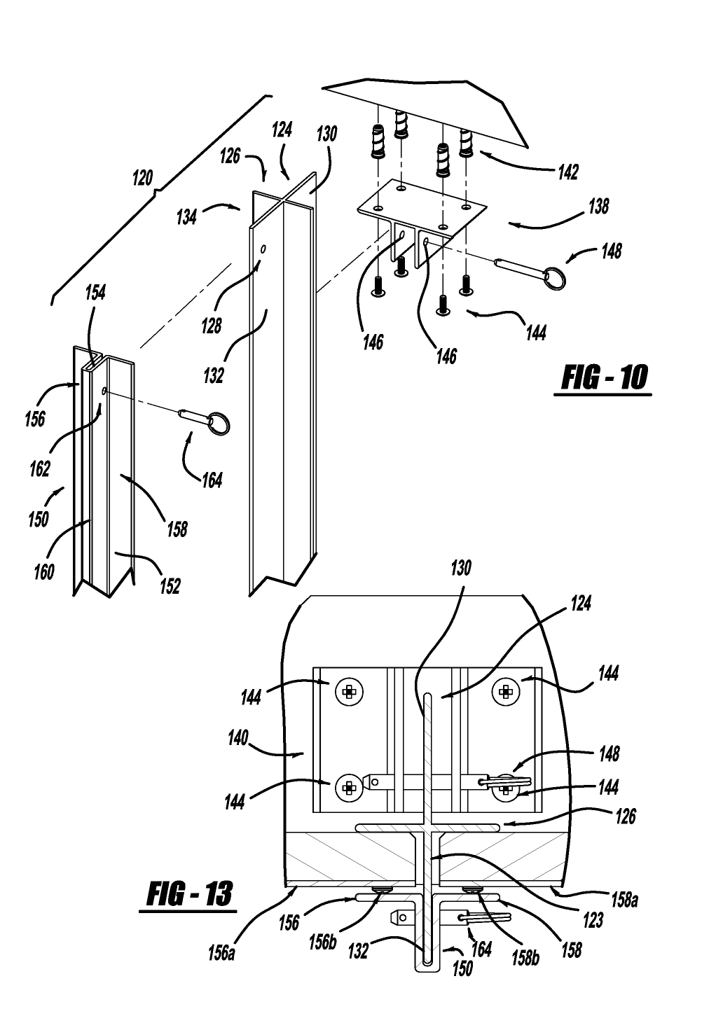

During deployment, the groove 154 of the web portion 160 is preferably disposed over the outboard surface 132 of the first portion 124 such that the through bores 162 align with at least one of the apertures 128 of the outboard surface 132 of the first portion 124. Preferably, several of the respective through bores 162 and apertures 128 align. Once this occurs, a second releasable interlock member 164 is slidably received in each of the aligned apertures 128 and through bores 162. By way of a non-limiting example, the interlock member 164 is preferably disposed between the aligned apertures 128 on the outboard portion 132 and through bores 164 (e.g., see FIGS. 12-14). The interlock members 164 can be formed to be fully disposed through both ends of the through bores 164. In this manner, the locking device 150 is securely releasably joined to the bracket member 122, especially from the exterior of the building or dwelling 108, thus ensuring that the shutters 102, 104 can be held in their closed position during any type of weather conditions. Movement or dislodgement of the locking device 150 in this orientation would take a tremendous amount of force. Essentially, the interlock members 164 would have to be blown or knocked out of position to permit the locking device 150 to be removed from the bracket member 122. As with the previously described embodiment, in an emergency situation wherein the occupants had to exit the structure exclusively through the window, the window (e.g., a slider, double hung, or inwardly opening casement window design) could be opened and the locking device 150 could be manually pulled out of its position and removed by the occupants wherein the shutters 102, 104 could be easily pushed open.

Although the preferred embodiment of the present invention has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

What is claimed is:

1. A locking system for securing a shutter in place, comprising:
a bracket member extending vertically in an opening formed in a structure, the bracket member having a face portion and a web portion extending perpendicularly from the face portion, wherein the web portion includes a through bore formed there through, wherein the face portion includes a vertically extending groove, the groove bisecting the through bore;
at least one interlock member selectively operable to be received in the through bore; and
a locking member having a face portion and a web portion extending perpendicularly from the face portion of the locking member, wherein the web portion of the locking member is selectively operable to be received within the groove, wherein the locking member is selectively operable to engage the interlock member, wherein the shutter is selectively operable to be held in place between the face portion of the bracket member and the face portion of the locking member when the locking member engages the interlock member.

2. The invention according to claim 1, wherein the bracket member includes a first mounting plate secured to a lower surface of the opening and a second mounting plate secured to an upper surface of the opening.

3. The invention according to claim 2, wherein either of the first and second mounting plates includes a through bore formed there through.

4. The invention according to claim 3, further comprising at least one other interlock member selectively operable to be received in the through bore formed in either of the first and second mounting plates.

5. The invention according to claim 4, wherein the locking member is selectively operable to engage the other interlock member, wherein the shutter is selectively operable to be held in place between the face portion of the bracket member and the face portion of the locking member when the locking member engages the other interlock member.

6. The invention according to claim 1, wherein the locking member includes an area defining a notch formed therein.

7. The invention according to claim 6, wherein the notch includes a horizontally extending surface and a vertically extending surface.

8. The invention according to claim 7, wherein the interlock member is selectively operable to engage both the horizontally extending surface and the vertically extending surface.

9. The invention according to claim 8, wherein when the interlock member engages the vertically extending surface of the locking member, the shutter is selectively operable to be held in place between the face portion of the bracket member and the face portion of the locking member.

10. The invention according to claim 1, wherein the locking member includes a handle member.

11. A locking system for securing a shutter in place, comprising:
a bracket member extending vertically in an opening formed in a structure, the bracket member having a face portion and a web portion bisecting one another, wherein the web portion includes at least one through bore formed there through;
a locking member having a face portion and a web portion extending perpendicularly from the face portion of the locking member, wherein the web portion of the bracket member is selectively operable to be received within the groove, wherein the web portion of the locking member includes at least one through bore formed there through; and
an interlock member selectively operable to be received in the through bores of the web portion of the bracket member and the web portion of the locking member, wherein the shutter is selectively operable to be held in place between the face portion of the bracket member and the face portion of the locking member when the interlock member engages the through bores of the web portion of the bracket member and the web portion of the locking member.

12. The invention according to claim 11, wherein the bracket member includes a first mounting plate secured to a lower surface of the opening and a second mounting plate secured to an upper surface of the opening.

13. The invention according to claim 12, wherein either of the first and second mounting plates includes a through bore formed there through.

14. The invention according to claim 13, further comprising at least one other interlock member selectively operable to be received in the through bore formed in either of the first and second mounting plates.

15. The invention according to claim 14, wherein the other interlock member is selectively operable to engage the bracket member.

16. The invention according to claim 11, wherein when the interlock member is received in the through bores of the web portion of the bracket member and the web portion of the locking member, the shutter is selectively operable to be held in place between the face portion of the bracket member and the face portion of the locking member.

17. The invention according to claim 11, wherein the web portion of the bracket member includes a first surface and a second surface, each of the first and second surfaces including a through bore formed there through.

18. The invention according to claim 17, wherein an interlock member is selectively operable to connect either the first or second surface of the web portion of the bracket member to a mounting plate.

19. The invention according to claim 17, wherein an interlock member is selectively operable to connect either the first or second surface of the web portion of the bracket member to the locking member.
